(19) United States
(12) Patent Application Publication
(10) Pub. No.: US 2015/0192195 A1
(43) Pub. Date: Jul. 9, 2015

(54) GEARS AND MANUFACTURING METHOD THEREOF

(71) Applicants: Daisuke Okamoto, Fujinomiya-shi (JP); Naoki Moriguchi, Susono-shi (JP); Morihiro Matsumoto, Susono-shi (JP); Masayuki Ishibashi, Numazu-shi (JP); Daisuke Tokozakura, Susono-shi (JP)

(72) Inventors: Daisuke Okamoto, Fujinomiya-shi (JP); Naoki Moriguchi, Susono-shi (JP); Morihiro Matsumoto, Susono-shi (JP); Masayuki Ishibashi, Numazu-shi (JP); Daisuke Tokozakura, Susono-shi (JP)

(73) Assignee: TOYOTA JIDOSHA KABUSHIKI KAISHA, Toyota-shi, Aichi-ken (JP)

(21) Appl. No.: 14/420,182

(22) PCT Filed: Nov. 5, 2013
(86) PCT No.: PCT/IB2013/002445

§ 371 Date: Feb. 6, 2015

(30) Foreign Application Priority Data
Nov. 7, 2012 (JP) 2012-245522

(51) Int. Cl. F16H 55/06; B23F 19/00; F16H 55/17

(52) U.S. Cl. CPC F16H 55/06; F16H 55/17; B23F 19/00

(57) ABSTRACT

Provided are gears in which flanks of mutually meshing teeth are polished and finished to a predetermined surface texture. In the gears, the arithmetic mean roughness Ra of the tooth flanks is equal to or less than 0.15 μm and the peak height Rpk satisfies 0.01 μm<Rpk<0.1 μm after the finishing and before use.

### BACKGROUND OF THE INVENTION

1. Field of the Invention

The invention relates to gears that transmit a torque by meshing and rotating together and that have a revolution speed ratio corresponding to the number of teeth therein, and to a manufacturing method thereof. More particularly, the invention relates to a surface texture of tooth flanks.

2. Description of Related Art

When power is transmitted by meshing gears, power loss occurs due to unavoidable slip at the tooth flanks. Accordingly, attempts have been made to reduce a friction coefficient at the tooth flanks while maintaining the tooth flank strength. In order to reduce the friction coefficient at the tooth flanks, it is necessary to decrease the roughness of the tooth flanks to decrease the so-called metal contact and retain reliably an oil film formed by lubricating oil. For example, in the technology described in Japanese Patent Application Publication No. 7-293668 (JP 7-293668 A), a plateau-like tooth flank is formed that has the skewness Rsk of the roughness curve of the tooth flank equal to or higher than “−5” and equal to or less than “−0.2”. Such a configuration serves to increase the strength against damage such as pitting and scoring, and because the tooth flank has a plateau-like shape, the metal contact reduction ability and the lubricating oil retaining ability can be both increased, and the friction coefficient can be reduced. Further, in the method for manufacturing a gear described in JP 7-293668 A, the maximum roughness Rmax of the tooth flank prior to polishing is made equal to or less than 5 μm, the mean roughness Ra is made 0.5 μm, and the surface is removed correspondingly to the roughness to a thickness that is 0.2 to 2 times the maximum roughness Rmax.

Further, International Patent Application No. 2004/081156 describes the surface roughness of a drive gear of an electric power steering device and indicates that the arithmetic mean roughness Ra of the tooth flank is 0.008 to 0.15 μm. Such a configuration serves to decrease the so-called protrusions and depressions on the tooth flank, increase a power transmission efficiency, and also prevent the decrease in durability and service lift caused by insufficient lubrication. Japanese Patent Application Publication No. 2011-137492 (JP 2011-137492 A) indicates that the peak height Rpk at the surface of a pulley in a belt-type continuous variable transmission is equal to or less than 0.09 μm, and the configuration described in JP 2011-137492 A can increase the oil retaining ability.

Where the tooth flank has a plateau-like shape with the skewness Rsk of the roughness curve within the above-mentioned range of negative values, as described in JP 7-293668 A, sharp protruding portions are reduced in size, thereby reducing the friction coefficient. However, where the maximum roughness Rmax and arithmetic mean roughness. Ra are increased prior to polishing, as indicated in JP 7-293668 A, and the plateau-like shape is obtained by chemical polishing and electrolytic polishing, with the thickness removed by polishing being 0.2 to 2 times the maximum roughness Rmax, as indicated in JP 7-293668 A, although the sharp protruding portions are initially polished, dissolved, and removed, since the entire surface is thereafter polished with the projecting sections being preferentially polished, the .depth of the receding portions or depressions called “valleys” is reduced. As a result, in the configuration described in JP 7-293668 A, the tooth flank is subjected to the so-called flattening, and the oil retaining ability is degraded.

Meanwhile, where the arithmetic mean roughness of the tooth flank is made within a range of 0.008 to 0.15 μm, as indicated in International Patent Application No. 2004/081156, the oil retaining ability is apparently improved, but since the friction coefficient and power transmission efficiency in the case of power transmission by gears depend not only on oil retaining ability, the technology disclosed in International Patent Application No. 2004/081156 does not necessarily improve the power transmission efficiency. The technology disclosed in JP 2011-137492 A relates to the surface shape of a pulley in a belt-type continuously variable transmission, whereas, in the present application the power is transmitted by meshing of gear teeth and, therefore, ideal properties required for the surface are technologically significantly different.

### SUMMARY OF THE INVENTION

It is an object of the invention to provide gears that can reduce the friction coefficient and increase the power transmission efficiency even when the oil film is thin, and also to provide a manufacturing method therefor.

According to a first aspect of the invention, in gears in which flanks of mutually meshing teeth are polished and finished to a predetermined surface texture, an arithmetic mean roughness Ra of the tooth flanks is equal to or less than 0.15 μm and a peak height Rpk satisfies 0.01 μm≦Rpk≦0.1 μm after the finishing. The arithmetic mean roughness Ra of the tooth flanks may be applied to the gears before use.

According to a second aspect of the invention, a method for manufacturing gears by polishing flanks of teeth that mesh together to transmit power and thereby finishing the tooth flanks to a predetermined surface texture includes polishing the tooth flanks to an arithmetic mean roughness Ra equal to or less than 0.15 μm and a peak height Rpk satisfying 0.01 μm≦Rpk≦0.1 μm.

According to the first and second aspects of the invention, even when-the oil film is reduced in thickness, for example, by the decrease in relative speed at the flanks of the mutually meshing teeth, the friction coefficient can be reduced and the power transmission efficiency can be improved. Further, gears that excel in power transmission efficiency from the start of use can be obtained. Specific features of the surface texture affecting the friction coefficient have been experimentally clarified based on the difference in oil film thickness, and the gears excel in power transmission efficiency because the surface texture can be regulated by factors representing the surface texture demonstrating such specific features.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram for explaining the arithmetic mean roughness;

FIG. 2 is a schematic diagram for explaining the peak height;

FIG. 3 is a schematic diagram for explaining the relationship between the roughness of tooth flank, thickness of oil film, and ratio of metal share portion;

FIG. 4 illustrates the contribution ratios of factors representing the surface texture to the friction coefficient;

FIG. 5 illustrates how the efficiency converges to a predetermined value in long-term breaking-in operation;

FIG. 6 illustrates how the protrusion-combined root-mean-square roughness converges to a predetermined value in long-term break-in operation;

FIG. 7A shows the results obtained in measuring the relationship between the arithmetic mean roughness and efficiency, and FIG. 7B shows the results obtained in measuring the relationship between the peak height and efficiency;

FIG. 8 is a diagram representing both the arithmetic mean roughness and the peak height in gears of comparative examples and an example of the invention; and

FIGS. 9A, 9B, 9C, and 9D show the efficiency for each transmission torque obtained in comparative examples and an example of the invention for different revolution speeds.

### DETAILED DESCRIPTION OF EMBODIMENTS

The gears according to an embodiment of the invention are suitable for transmitting comparatively large power in vehicles and various industrial machines, for example, suitable for use in transmissions. Further, the gears are typically helical gears, but may be also gears of another structure, such as spur gears. The gears in accordance with the embodiment are basically manufactured by the same process as that used to manufacture the typical conventional gears. Thus, a raw blank is produced by processing, such as rolling, turning, or gear cutting, from a source material, grinding the teeth or performing the appropriate surface treatment thereof, and then polishing the tooth flanks. The polishing method may be the appropriate conventional method such as chemical polishing, electrolytic polishing, or resin polishing using a resin.

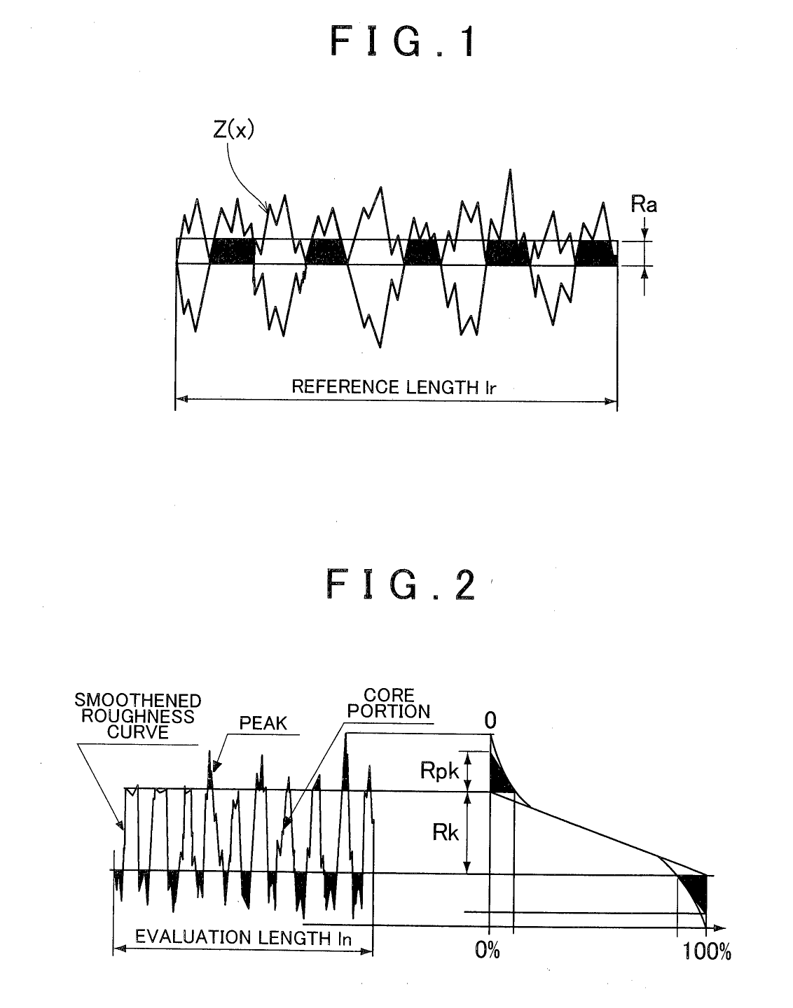

In the embodiment, an arithmetic mean roughness Ra equal to or less than 0.15 μm and a peak height Rpk of 0.01 μm or greater to 0.1 μm or less are set as a surface texture of the teeth transmitting power by meshing with each other. In this case, the arithmetic mean roughness Ra is stipulated by Japanese Industrial Standard (JIS) B0601 (2001) and is a value obtained by sampling from a roughness curve Z(x) a portion corresponding to a reference length in the direction of a mean line thereof, adding up the absolute values (height, depth) of deviations from the mean line of the sampled portion to the measurement curve, and averaging. The arithmetic mean roughness is shown schematically in FIG. 1. The peak height Rpk is stipulated by JIS B0671 (2002) and is an average value of peak heights on a core portion in an evaluation length ln of a smoothened roughness curve. The peak height is shown schematically in FIG. 2.

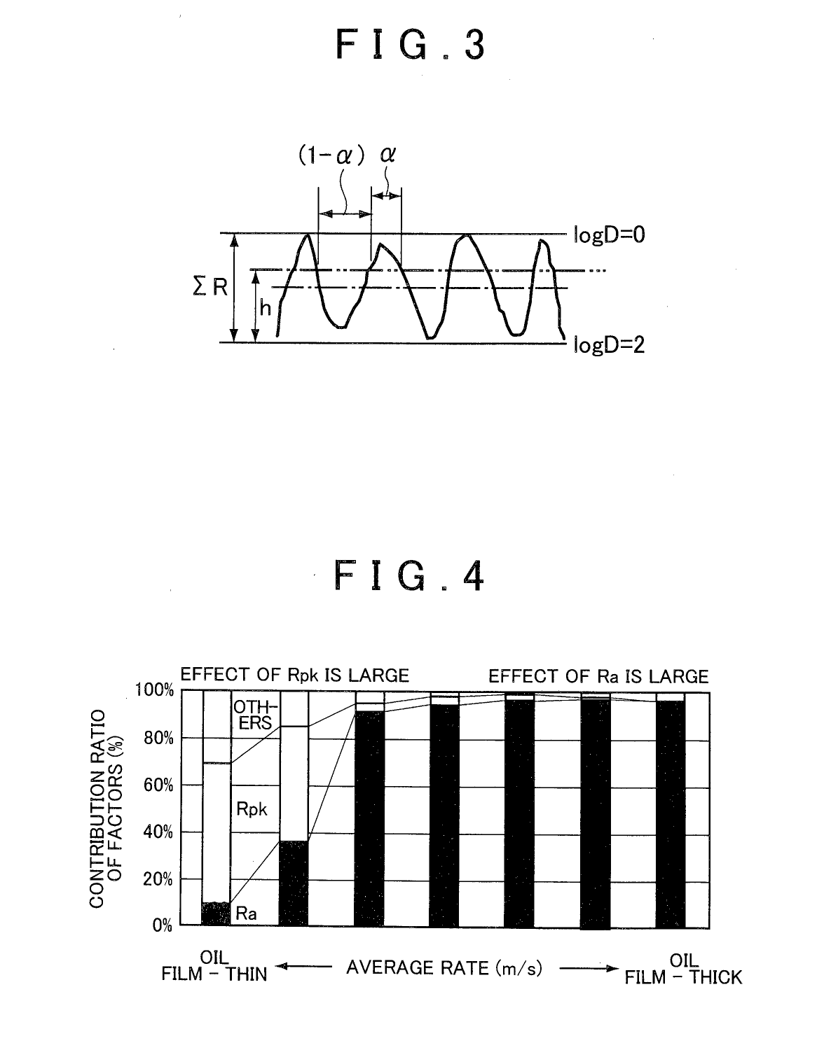

In the embodiment, the peak height Rpk is set to be equal to or less than 0.1 μm for the following reason. Where power is transmitted by a pair of mutually meshing gears, unavoidable slip occurs at the tooth flanks, and power loss caused by the friction affects the power transmission efficiency. As the tooth flanks come into contact, with an oil film being interposed therebetween, metals constituting the teeth are apparently also in contact with each other in other portions at the same time. Therefore, the friction coefficient p of the entire body satisfies μ=(1−α)μ_{L}+αμ_{S}. Here, μ_{L} is the friction coefficient of the oil film share portion, pₛ is the friction coefficient of the metal share portion, and a is the ratio of the metal share portion, and this a can be represented by the following equation: α=A·log(D)D=ΣR/h, where A is a constant, for example, “0.5”. In this equation h is the oil film thickness, and ΣR is the height of depressions and protrusions on the surface. The relationship between the oil film thickness h and the height ΣR is shown schematically in FIG. 3. Since the friction coefficient μ_{D} of the metal share portion is several times to more than dozen times the friction coefficient μ_{L} of the oil film share portion, it is clear that from the standpoint of decreasing the friction coefficient p of the entire body (referred to hereinbelow simply as “friction coefficient”), it is preferred that the oil film retention characteristic be improved, that is, the ratio of the metal contact be reduced.

The oil film retention ability of a tooth flank depends on the surface texture of the tooth flank. Therefore, the friction coefficient μ is affected by the surface texture of the tooth flank. FIG. 4 shows the results obtained by examining the contribution ratio of factors determining the surface texture to the friction coefficient μ. The oil film thickness decreases with the decrease in the relative slip rate of the tooth flanks, and as the oil film becomes thinner, the degree of contribution of the arithmetic mean roughness Ra decreases and the degree of contribution of the peak height Rpk increases. Therefore, in order to obtain the desirably small friction coefficient μ even when the film thickness is thin, which is a severe condition in terms of reducing the friction coefficient μ, it is necessary to optimize the peak height Rpk.

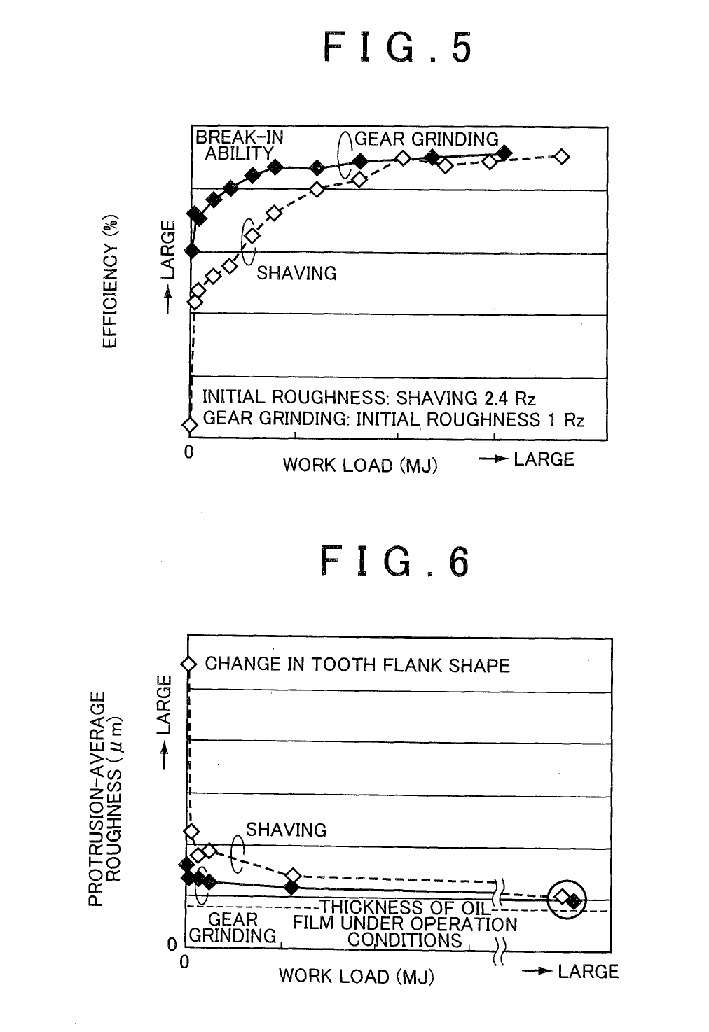

Meanwhile, due to the unavoidable slip that accompanies the transmission of power, the tooth flanks are worn out and the flanks of the mutually meshing teeth are gradually broken in. FIG. 5 shows the results obtained by examining the break-in ability. The results of break-in investigation shown in FIG. 5 are obtained for gears produced by polishing (gear grinding) the tooth flanks to a predetermined initial roughness (maximum height) Rz and gears obtained by shaving the tooth flanks so that the initial roughness (maximum height) thereof becomes “2.4 times” the roughness Rz of the tooth flanks of the polished gears. The operation of transmitting a predetermined torque at a constant revolution speed is continuously performed, and the efficiency for each work load (MJ) is measured as a result thereof. The results shown in FIG. 5 indicate that the power transmission efficiency decreases as the roughness Rz of the tooth flanks increases, but where the operation is continued for a long time, the efficiency converges to a predetermined value, regardless of the value of the initial roughness Rz.

Changes in the shape of tooth flanks caused by long-term break-in operation have also been examined with respect to the abovementioned gears. FIG. 6 shows the results obtained by measuring the protrusion-combined root-mean-square roughness as variations in the tooth flank shape. It has been determined that the trend of the mean roughness to decrease weakens with the extension of the operation time (that is, with the increase in the work load), and the mean roughness eventually converges to almost a roughness slightly greater than the oil film thickness under the operation conditions at this point of time.

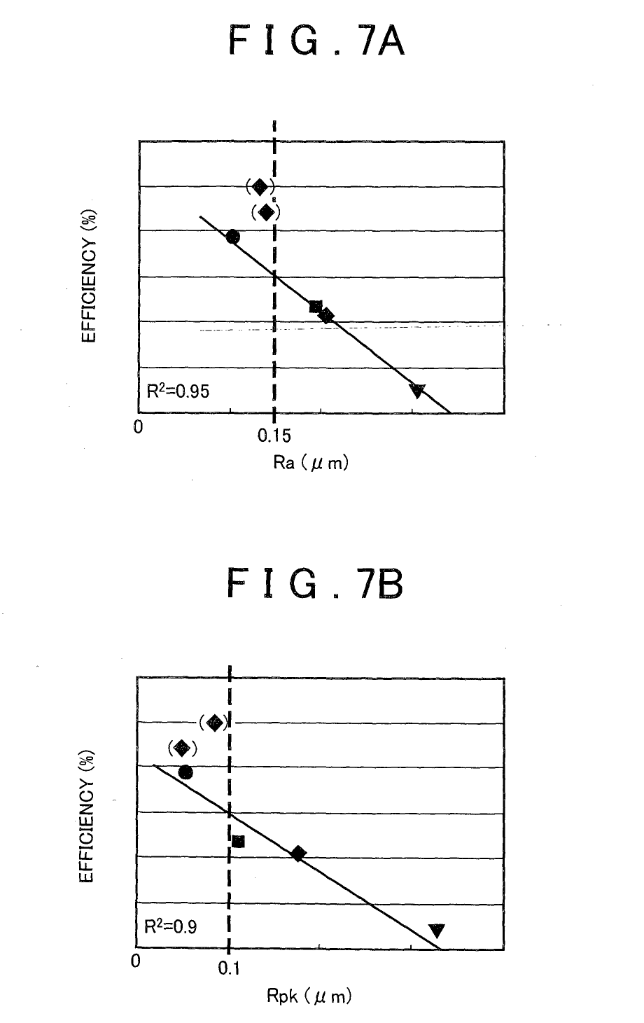

The above-described results suggest that where a long-term break-in operation is performed, the mutually meshing tooth flanks break in, the efficiency converges to a predetermined value, and the surface texture (in particular, roughness) of the tooth flanks converges accordingly to a predetermined value. Thus, the shape resulting from the convergence that balances the load shares of the oil film and metal represented by the equation above is apparently the surface shape after the long-term break-in operation. Further, the removal amount of the tooth flank surface that represents the surface shape after the long-term break-in operation is considered to have a threshold such that below this removal amount, the efficiency is decreased, and above this removal amount, the removal amount unnecessarily increases, resulted in damage in the flank surface and increase in cost. This indicates that the surface texture, in which the removal amount of-the protruding portions of the tooth flank surface can be minimized and the load shares of the oil film and metal can be balanced, can be manufactured on the basis of the removal amount of the tooth flank surface that represents the surface shape after the long-term break-in operation. FIG. 7A shows the relationship between the arithmetic mean roughness Ra and power transmission efficiency determined experimentally on the basis of the above-described assumption. FIG. 7B shows the experimentally determined relationship between the peak height Rpk and power transmission efficiency.

In FIG. 7A, the arithmetic mean roughness Ra (μm) is plotted against the abscissa, and the efficiency (%) is plotted against the ordinate. “R²” is a determination factor that indicates how well the results fit on a straight line. This factor has a very high value of “0.95”. Three test gears with the arithmetic mean roughness Ra greater than 0.15 pm and one test gear with the arithmetic mean roughness less than 0.15 μm are fabricated by removing the protrusions on the tooth flanks by an appropriate method, and the efficiency of the gears is measured. In FIG. 7A, the measurement results relating to two gears after a long-term break-in operation conducted till the efficiency and the protrusion-combined root-mean-square roughness converge to respective predetermined values are plotted in parentheses. The results indicate that an arithmetic mean roughness Ra equal to or less than 0.15 μm is necessary to minimize the removal amount of the protruding portions on the tooth flank surface and balance the load shares of the oil film and metal.

Therefore, where the arithmetic mean roughness Ra of the tooth flanks exceeds 0.15 μm or a value close thereto, the efficiency decreases with respect to the efficiency eventually attainable with the gears, and fuel efficiency of the vehicle is degraded till the gears break in with each other after long-term operation.

Meanwhile, FIG. 7B shows the relationship between the efficiency and the peak height Rpk that is measured for the above-mentioned four test gears. In FIG. 7B, the measurement results relating to two gears after a long-term break-in operation conducted till the efficiency and the protrusion-combined root-mean-square roughness converge to respective predetermined values are plotted in parentheses. The results indicate that a peak height Rpk equal to or less than 0.1 μm is necessary to minimize the removal amount of the protruding portions on the tooth flank surface and balance the load shares of the oil film and metal.

Therefore, where the peak height Rpk of the tooth flanks exceeds 0.1 μm or a value close thereto, the efficiency decreases with respect to the efficiency eventually attainable with the gears, and fuel efficiency of the vehicle is degraded till the gears break in with each other after long-term operation.

The specifications of the test gears used to obtain the measurement results shown in FIGS. 7A and 7B are described below. The drive gear and the driven gear are both helical gears, the torsion angle is “36°”, the module is “2”, the pressure angle is “16.5°”, the number of teeth in the drive gear is “35”, the number of teeth in the driven gear is “25”, and the center distance is “74 mm”. The revolution speed at which the efficiency is measured is assumed as a revolution speed in the case of a cruising state of the vehicle, and the input torque is a torque occurring in the cruising state of the vehicle in which the gears are expected to be loaded.

The oil film thickness is explained herein as a reference. The oil film thickness is calculated by the following Chittenden's equation, but other methods for calculating the oil film thickness may be also used.

$$\frac{{h}_{c}}{{R}_{x}} = 4.31 {( \frac{{η}_{0} u}{{ER}_{x}} )}^{0.68} {( α E )}^{0.49} {( \frac{W}{{ER}_{x}^{2}} )}^{- 0.073} [ 1 - exp \{ - 1.23 {( {R}_{y} / {R}_{x} )}^{2 / 3} \} ] \qquad [ Formula 1 ]$$

Here, E is an elastic constant of a roller material, u is an average rolling speed (=(u₁+u₂)/2), Rₓ is a value represented by (Rₓ₁⁻¹+Rₓ₂⁻¹)⁻¹, where Rₓ₁, Rₓ₂ stand for radii of mutually orthogonal main-curvature surfaces of contacting ellipsoids, R_{y} is a value represented by (R_{y1}⁻¹+R_{y2}⁻¹)⁻¹, where R_{y1}, Ryₑ stand for, radii of other main-curvature surfaces, η₀ is, an oil viscosity under atmospheric pressure, and α is an oil viscosity—pressure coefficient, which is about “20 Gpa⁻¹” in the usual mineral oil.

The above-described results obtained by tests and measurements indicate that, in the gears of the embodiment, a peak height Rpk of 0.01 μm or greater to 0.1 μm or less and the arithmetic mean roughness Ra equal to or less than 0.15 μm are taken as the surface texture of the tooth flanks. With the manufacturing method of the embodiment, When the tooth flanks are polished, the polishing is performed such as to obtain the peak height Rpk and the arithmetic mean roughness Ra such as described hereinabove. The lower limit value of the peak height Rpk is set to “0.01 μm” because by leaving the protruding peaks, it is possible to ensure the so-called two-layer cross-sectional structure of the tooth flank and provide depressions functioning as oil reservoirs, thereby increasing the oil film retention ability. The peak height Rpk and arithmetic mean roughness Ra mentioned herein are values at a stage after the polishing of the tooth flanks has been completed and before the gears are used. Therefore, with the gears of the embodiment or the gears produced by the method of the embodiment in which the processing is performed to obtain the aforementioned surface texture, the surface texture that has been conventionally reached after long-term operation is provided in advance. Therefore, a high power transmission efficiency can be attained from the very beginning of use and fuel efficiency of the vehicle can be improved. Further, since the friction coefficient of the tooth flanks is decreased, the damage of tooth flanks is prevented or inhibited which is impossible with the conventional gears.

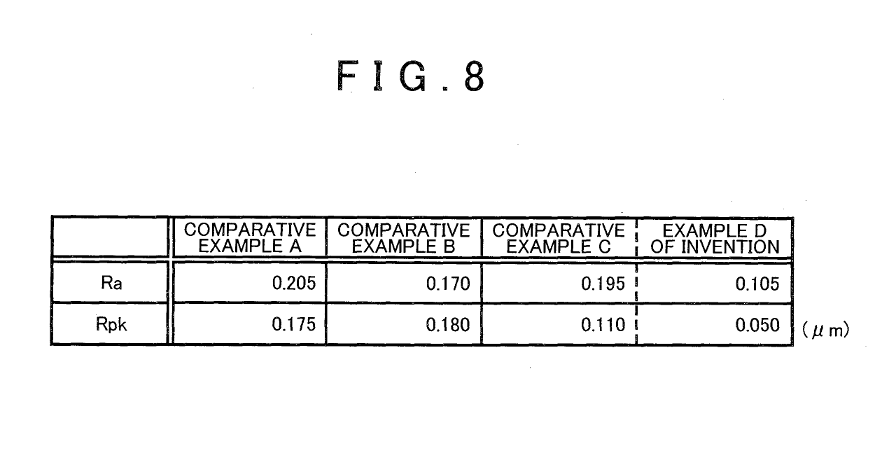

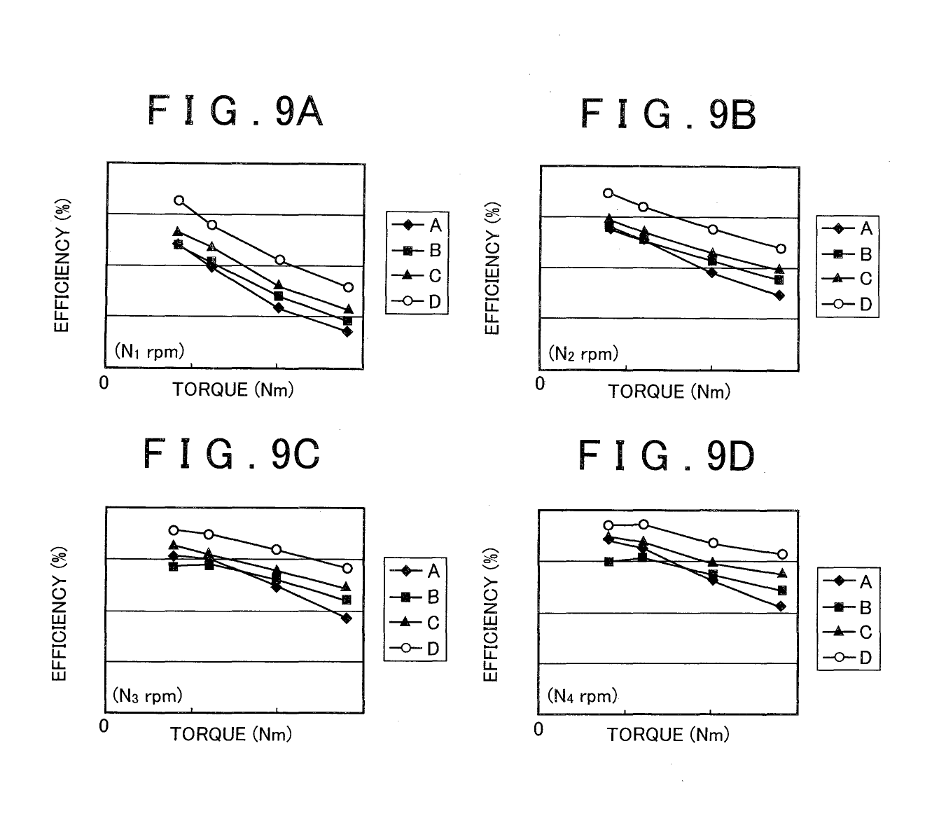

A specific example and comparative examples of the embodiment are described below. The specifications of gears in the examples are the same as those of the above-described test gears. The gears for which the peak height Rpk and the arithmetic mean roughness Ra are outside the ranges stipulated by the embodiment represent the comparative examples (A, B, and C), and the gears in which those parameters are within the ranges stipulated by the embodiment represent the example (D) of the invention. The revolution speeds in the examples are N1, N2, N3, and N4 (N1<N2<N3<N4), respectively, and the efficiency is measured with respect to a case in which the transmission torque is gradually increased to a hundred and several tens of Nm. The arithmetic mean roughness Ra and the peak height Rpk in the comparative examples and the example of the embodiment are shown in FIG. 8, and the results obtained by measuring the efficiency are shown in FIGS. 9A to 9D.

The efficiency improves with the decrease in the transmitted torque and increase in the revolution speed for all of the gears of the comparative examples and the example of the invention. In the example of the invention, the efficiency is higher than in the comparative examples, and the efficiency improvement effect becomes remarkable at a lower revolution speed.

1. Gears comprising:
teeth that mesh together, the teeth having flanks that are polished and finished to a predetermined surface texture,
an arithmetic mean roughness Ra of the tooth flanks being equal to or less than 0.15 pm and a peak height Rpk satisfying 0.01 μm≦Rpk≦0.1 μm after the finishing.

2. A method for manufacturing gears by polishing flanks of teeth that mesh together to transmit power and thereby finishing the tooth flanks to a predetermined surface texture, the method comprising:
polishing the tooth flanks to an arithmetic mean roughness Ra equal to or less than 0.15 μm and a peak height Rpk satisfying 0.01 μm≦Rpk≦0.1 μm.
